(19) United States
(12) Patent Application Publication
(10) Pub. No.: US 2026/0113764 A1
(43) Pub. Date: Apr. 23, 2026

(54) APPARATUS AND METHOD FOR HANDLING INTERLACING OF PHYSICAL RESOURCE BLOCKS IN A SIDELINK COMMUNICATION

(71) Applicant: Lenovo (Singapore) Pte. Limited, Singapore (SG)

(72) Inventors: Karthikeyan Ganesan, Nauheim (DE); Alexander Golitschek Edler von Elbwart, Darmstadt (DE)

(73) Assignee: Lenovo (Singapore) Pte. Limited, Singapore (SG)

(21) Appl. No.: 19/111,371

(22) PCT Filed: Sep. 28, 2023
(86) PCT No.: PCT/IB2023/059730

§ 371 Date: Mar. 13, 2025

Related U.S. Application Data
(60) Provisional application No. 63/411,230, filed on Sep. 29, 2022.

(51) Int. Cl. H04W 72/40

(52) U.S. Cl. CPC H04W 72/40

(57) ABSTRACT

An apparatus and method are provided where an interlaced based resource block configuration is received (702), which includes a physical resource block mapping for one or more bandwidth parts. Each bandwidth part includes a plurality of resource block sets each having a first defined size for mapping a plurality of subchannels of a second defined size into the respective resource block set, where the second defined size does not divide evenly into the first defined size. One or more remaining physical resource blocks that number less than the second defined size remain unassigned after a maximum number of subchannels are created. The remaining physical resource blocks are associated with one or more common interlaces for use as resource blocks for use as part of one or more physical sidelink feedback channels (704).

### FIELD OF THE INVENTION

The present disclosure is directed to the handling of the interlacing of physical resource blocks in a sidelink communication, and more particularly to the management of the interlacing for physical resource blocks that are remaining in a resource block set after one or more subchannels are defined, therein.

### BACKGROUND OF THE INVENTION

Presently, user equipment, such as wireless communication devices, communicate with other communication devices using wireless signals, such as within a network environment that can include one or more cells within which various communication connections with the network and other devices operating within the network can be supported. Network environments often involve one or more sets of standards, which each define various aspects of any communication connection being made when using the corresponding standard within the network environment. Examples of developing and/or existing standards include new radio access technology (NR), Long Term Evolution (LTE), Universal Mobile Telecommunications Service (UMTS), Global System for Mobile Communication (GSM), and/or Enhanced Data GSM Environment (EDGE).

As part of functioning within many communication networks, such as cellular communication networks, a large part of supporting communications can often involve the use of spectrum resources, that are largely auctioned/licensed for use to a specific service provider through appropriate governing authorities. The amount of licensed spectrum that a service provider has obtained the rights to use often correlates to the overall amount of information throughput that can be more directly supported. As a way of expanding capabilities and information throughput, service providers have been increasingly looking toward unlicensed frequencies, that are available for general use, as a way to support enhanced functionality and communication throughput.

Communications in an unlicensed portion of the spectrum can sometimes involve a form of communication referred to as listen before talk (LBT). In LBT, a radio transmitter will often sense the radio environment for activity from other sources in the radio channel space of interest (listen), before attempting to transmit (talk), after the radio channel space is determined to be relatively clear of other already existing communications. In order to determine whether a particular radio channel is clear, when listening to the channel space, a channel space's power spectral density and minimum channel occupancy may be considered as part of a clear channel assessment.

In at least some instances, a channel space may be subdivided into one or more subchannels, and in at least some of these instances, the size of the subchannel may not divide evenly into the size of the channel space. This can sometimes result in a few resource elements that are present in the channel space, that do not belong to any of the defined subchannels. These are sometimes called irregular or remaining physical resource blocks. If these resources remain undefined they will sometimes go unused, even if a device is making use of a particular channel space. In turn, these unused resource may contribute to the channel space's power spectral density and minimum channel occupancy, which could deflate the perceived usage of the channel. If the perceived usage falls below a predefined usage threshold, such as a channel occupancy of 80 percent, the channel may be determined to be no longer be in use, and may be deemed to be available for another device to make use of this channel space.

The present inventors have recognized that it may be possible to better organize the use of a channel space, so as to reduce the amount of unused irregular or remaining physical resource blocks that are present in a particular channel space being used by a device, as well as better manage the positioning of these resource blocks including the interleaving of the physical resource blocks associated with one or more (sub)channels and one or more physical sidelink feedback channels in a particular channel space, so as to reduce the possible misperception, that a channel space may not be in use.

### SUMMARY

The present application provides a user equipment (UE). The UE includes at least one controller coupled with at least one memory and configured to cause the UE to receive an interlaced based resource block configuration, which includes a physical resource block mapping for one or more bandwidth parts. Each bandwidth part includes a plurality of resource block sets each having a first defined size of resource blocks for mapping a plurality of subchannels of a second defined size of resource blocks into the respective resource block set, where the second defined size of the subchannel does not divide evenly into the first defined size of the resource block set. This results in one or more remaining physical resource blocks that number less than the second defined size of the subchannel which remain unassigned after a maximum number of subchannels are created within a particular one of the plurality of resource block sets. The user equipment further includes a controller for associating the one or more remaining physical resource blocks with one or more common interlaces for use as resource blocks for use as part of one or more physical sidelink feedback channels. An indication is provided of the one or more common interlaces.

According to another possible embodiment, a processor for wireless communication in a user equipment (UE) is provided. The processor includes at least one controller coupled with at least one memory and configured to cause the UE to receive an interlaced based resource block configuration, which includes a physical resource block mapping for one or more bandwidth parts. Each bandwidth part includes a plurality of resource block sets each having a first defined size of resource blocks for mapping a plurality of subchannels of a second defined size of resource blocks into the respective resource block set, where the second defined size of the subchannel does not divide evenly into the first defined size of the resource block set. This results in one or more remaining physical resource blocks that number less than the second defined size of the subchannel which remain unassigned after a maximum number of subchannels are created within a particular one of the plurality of resource block sets. The user equipment further includes a controller for associating the one or more remaining physical resource blocks with one or more common interlaces for use as resource blocks for use as part of one or more physical sidelink feedback channels. An indication is provided of the one or more common interlaces.

According to a further possible embodiment, a network entity is provided. The network entity includes at least one controller coupled with at least one memory and configured to cause the network entity to transmit an interlaced based resource block configuration, which includes a physical resource block mapping for one or more bandwidth parts. Each bandwidth part includes a plurality of resource block sets each having a first defined size of resource blocks for mapping a plurality of subchannels of a second defined size of resource blocks into the respective resource block set, where the second defined size of the subchannel does not divide evenly into the first defined size of the resource block set. This results in one or more remaining physical resource blocks that number less than the second defined size of the subchannel which remain unassigned after a maximum number of subchannels are created within a particular one of the plurality of resource block sets. The one or more remaining physical resource blocks are associated with one or more common interlaces for use as resource blocks for use as part of one or more physical sidelink feedback channels. An indication is provided of the one or more common interlaces.

According to a still further possible embodiment, a method in a user equipment is provided. The method includes receiving an interlaced based resource block configuration, which includes a physical resource block mapping for one or more bandwidth parts. Each bandwidth part includes a plurality of resource block sets each having a first defined size of resource blocks for mapping a plurality of subchannels of a second defined size of resource blocks into the respective resource block set, where the second defined size of the subchannel does not divide evenly into the first defined size of the resource block set. This results in one or more remaining physical resource blocks that number less than the second defined size of the subchannel which remain unassigned after a maximum number of subchannels are created within a particular one of the plurality of resource block sets. The one or more remaining physical resource blocks are associated with one or more common interlaces for use as resource blocks for use as part of one or more physical sidelink feedback channels. An indication of the one or more common interlaces are provided. These and other features, and advantages of the present application are evident from the following description of one or more preferred embodiments, with reference to the accompanying drawings.

### BRIEF DESCRIPTION OF THE DRAWINGS

FIG. 1 is a block diagram of an exemplary network environment in which the present invention is adapted to operate;

FIG. 2 is an exemplary resource pool structure;

FIG. 3 is an exemplary interlacing structure for a 20 Mhz LTE channel;

FIG. 4 is a resource block mapping, which illustrates the physical sidelink feedback channels for hybrid automatic repeat request (HARQ) feedback associated with different transmissions;

FIG. 5 is an exemplary interlace mapping for a 100 physical resource block set of a 20 MHz channel, which includes 8 subchannels, each having a size of 12 resource blocks for the physical sidelink control channel or the physical sidelink shared channel, as well as includes a corresponding 16 dedicated interlaces for the physical sidelink feedback channel, each having a size of 6 resource blocks;

FIG. 6 is an aggregated interlace mapping for a pair of resource block sets, which highlights respective interlaces for the physical sidelink control channel or the physical sidelink shared channel, respective dedicated interlaces for the physical sidelink feedback channel, as well as respective common interlaces associated with the remaining physical resource blocks;

FIG. 7 is a flow diagram in a user equipment the handling of the interlacing of physical resource blocks in a sidelink communication;

FIG. 8 is a flow diagram in a network entity the handling of the interlacing of physical resource blocks in a sidelink communication; and

FIG. 9 is an exemplary block diagram of an apparatus according to a possible embodiment.

### DETAILED DESCRIPTION OF THE PREFERRED EMBODIMENT(S)

While the present disclosure is susceptible of embodiment in various forms, there is shown in the drawings and will hereinafter be described presently preferred embodiments with the understanding that the present disclosure is to be considered an exemplification of the invention and is not intended to limit the invention to the specific embodiments illustrated.

Embodiments provide support for the management of the usage of physical resource blocks in a resource block set, as well as the handling of the interlacing of physical resource blocks as part of a sidelink communication in an unlicensed portion of the spectrum.

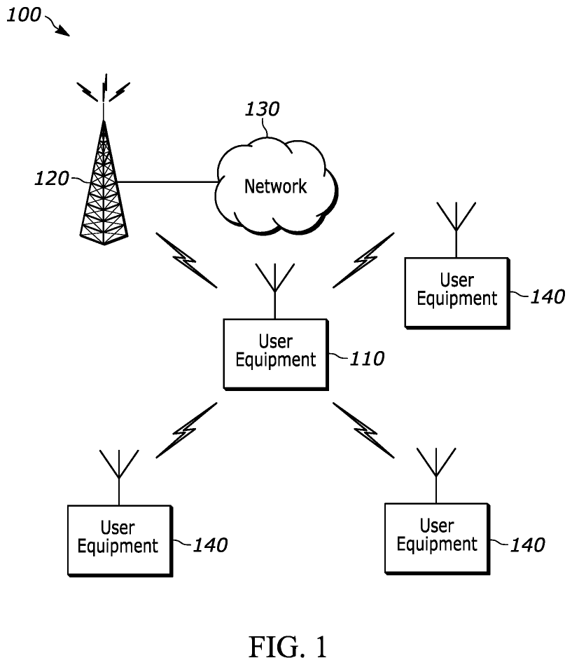

FIG. 1 is an example block diagram of a system 100 according to a possible embodiment. The system 100 can include a wireless communication device 110, such as User Equipment (UE), a base station 120, such as an enhanced NodeB (eNB) or next generation NodeB (gNB), and a network 130.

The wireless communication device 110 can be a wireless terminal, a portable wireless communication device, a smartphone, a cellular telephone, a flip phone, a personal digital assistant, a personal computer, a selective call receiver, a tablet computer, a laptop computer, or any other device that is capable of sending and receiving communication signals on a wireless network.

The network 130 can include any type of network that is capable of sending and receiving wireless communication signals. For example, the network 130 can include a wireless communication network, a cellular telephone network, a Time Division Multiple Access (TDMA)-based network, a Code Division Multiple Access (CDMA)-based network, an Orthogonal Frequency Division Multiple Access (OFDMA)-based network, a Long Term Evolution (LTE) network, a 5th generation (5G) network, a 3rd Generation Partnership Project (3GPP)-based network, a satellite communications network, a high altitude platform network, the Internet, and/or other communications networks.

In addition to and/or alternative to communicating with the network 130, the wireless communication device 110 may sometimes be able to communicate more directly with other wireless communication devices, such as user equipment 140. An example of this type of communication can sometimes be called peer-to-peer, and can sometimes relate to a sidelink type communication. In some instances, this can involve a targeted communication with a single entity, which is sometimes referred to as a unicast. In some instances, this can involve a targeted communication with multiple entities, which is sometimes referred to as a multi-cast. In some instances, this can involve an untargeted communication, which is available to any entity within transmission/reception range, which is sometimes referred to as a broadcast. In the illustrated embodiment, the base station 120 and the other user equipment 140 are potential communication targets of the wireless communication device 110.

Sidelink unlicensed operation is gaining momentum in Rel18 work item in the 3rd Generation Partnership Project (3GPP) and the transmission over the unlicensed spectrum for channels such as physical uplink shared channel (PUSCH), physical uplink control channel (PUCCH) format 2 etc., should meet the power spectral density (PSD) regulation and minimum channel occupancy (e.g., 80%). To fulfill these regulations, interlacing methods were defined in LTE-unlicensed and NR-unlicensed by interlacing PUSCH and PUCCH channels at resource block level. Sub-physical resource block (PRB) based interlacing was discussed during NR Rel16 considering higher subcarrier spacing (SCS), but eventually no agreement was reached.

In NR Rel16 sidelink resource allocation, the minimum scheduling unit is defined by sub-channels consisting of ‘N’ PRBs and ‘M’ sub-channels constitute a resource pool. Each sidelink (SL) carrier contains one SL bandwidth part (BWP) which is then associated with multiple transmit (Tx) Resource pools containing different configuration of the sub-channel sizes {n10, n12, n15, n20, n25, n50, n75, n100}. The minimum scheduling unit of sub-channel for sidelink contradicts that of uplink which is based on a resource block (RB) level scheduling unit and each resource pool in the sidelink does not span across the entire bandwidth or LBT subbands, which is the requirement for minimum occupancy and PSD limits. In order to meet the regulatory requirements of PSD and the minimum channel occupancy (i.e. 80%) for sidelink unlicensed operation requires the study of new interlacing methods by considering the traditional sidelink design of sub-channels and resource pools.

At least one concern involves the issue of how to handle the physical sidelink feedback channel (PSFCH) interlacing which includes meeting occupied channel bandwidth (OCB) and PSD requirements for PSFCH transmission using a RB-based interlace for PSFCH.

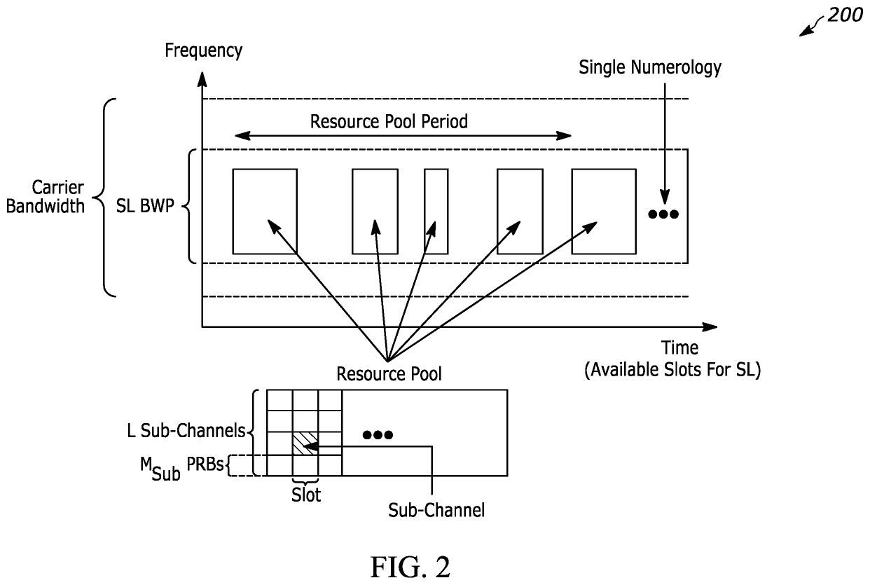

NR sidelink designed as part of Rel16 defines a resource pool structure within the SL BWP in a SL carrier. One or more resource pool structure (pre)configuration in 3GPP TS 38.331 contains subchannel size, and a bitmap of time slot and frequency resource as seen in FIG. 2. FIG. 2 illustrates an exemplary resource pool structure 200.

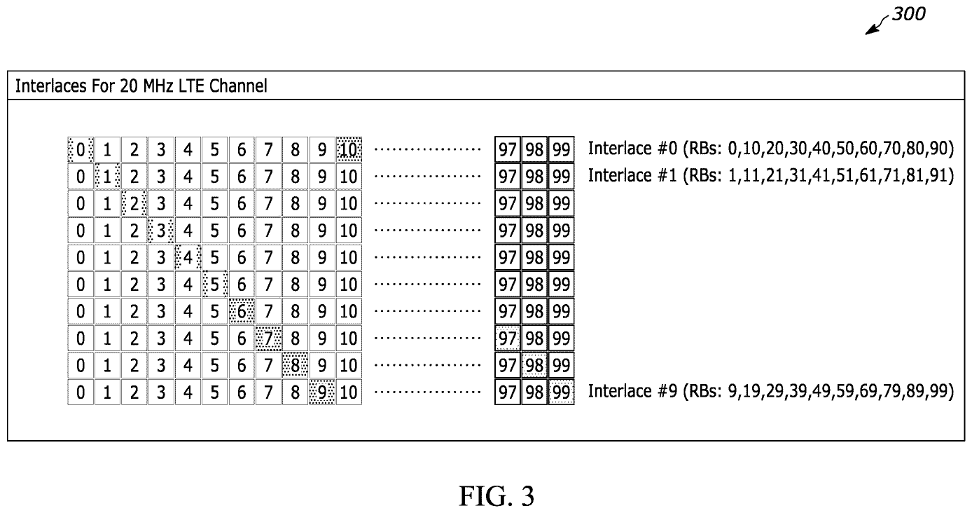

An interlace design is introduced as part of LTE licensed-assisted access (LAA) and NR-unlicensed operation in Rel16 to meet the PSD regulation and minimum channel occupancy (e.g., 80%). For a 20 MHz wide LTE channel, corresponding to 100 RB, there are ten interlaces with 10 RB per interlace. Interlace #0 contains resource blocks {0, 10, 20, 30, 40, 50, 60, 70, 80, 90}, as seen in FIG. 3. FIG. 3 illustrates an exemplary interlacing structure 300 for a 20 Mhz LTE channel.

Below are some of the NR Rel16 agreements and/or working assumptions about interlace design for uplink (UL) considering PUSCH and PUCCH transmission.
For a given subcarrier spacing (SCS), the following interlace design is supported at least for physical uplink shared channel (PUSCH):
   Same spacing (M) between consecutive PRBs in an interlace for all interlaces regardless of carrier BW, i.e., the number of PRBs per interlace is dependent on the carrier bandwidth,
   Point A is the reference for the interlace definition,
For 15 kHz SCS, M=10 interlaces and for 30 kHz SCS, M=5 interlaces for all bandwidths,
FFS: Interlace design for PUCCH for bandwidths greater than 20 MHz,
FFS: Whether and how partial interlace allocation is supported.
For interlaced PUSCH transmission in a BWP, X bits of the PUSCH frequency domain resource allocation field are used for indicating which combination of M interlaces is allocated to the UE.
This applies to PUSCH of the following types:
   Msg3 PUSCH
   PUSCH Scheduled by fallback and non-fallback DCIType 1 and Type 2 Configured Grant PUSCH
For 30 kHz SCS
   Support X=5 (5-bit bitmap to indicate all possible interlace combinations)
For 15 kHz SCS
   Down-select between the following two alternatives:
   Alt-1: Support X=10 (10-bit bitmap to indicate all possible interlace combinations)
   Alt-2: Support X=6 bits to indicate start interlace index and number of contiguous interlace indices (RIV) and using remaining up to 9 RIV values to indicate specific pre-defined interlace combinations.

From the RAN1 #98 agreement on interlace indication for PUSCH for 15 kHz SCS, Alt-2 is selected:
Support X=6 bits to indicate start interlace index and number of contiguous interlace indices (RIV) and using remaining up to 9 RIV values to indicate specific pre-defined interlace combinations
RIV values from 0 . . . 54 indicate start interlace index and number of consecutive interlace indices
RIV values from 55 . . . 63 indicate the following interlace combinations (from 36.213):

| RIV | Interlace Indexes |
|---|---|
| 55 | 0, 5 |
| 56 | 0, 1, 5, 6 |
| 57 | 1, 6 |
| 58 | 1, 2, 3, 4, 6, 7, 8, 9 |
| 59 | 2, 7 |
| 60 | 2, 3, 4, 7, 8, 9 |
| 61 | 3, 8 |
| 62 | 4, 9 |
| 63 | Reserved |

For interlaced PUSCH transmission in a BWP, Y bits of the frequency domain resource allocation (FDRA) field indicate which RB sets (corresponding to LBT bandwidths) are allocated to the UE
This applies to PUSCH of the following types
   PUSCH scheduled by at least non-fallback downlink control information (DCI)
FFS: applicability to fallback DCI
   Configured Grant PUSCH Type 2 (FDRA indicated by DCI)
   Configured Grant PUSCH Type 1 (FDRA configured by RRC)
The UE determines the overall PUSCH frequency domain resource allocation by the intersection of the following:
   Allocated interlaces (indicated by X bits of the FDRA field, as previously agreed)
   Available PRBs derived at least from the allocated RB sets (indicated by Y bits of the FDRA field) and intra-carrier guard bands between RB sets corresponding to contiguous LBT bandwidths
      Note: An RB set contains PRBs within an LBT bandwidth and does not include any inter or intra carrier guard PRBs
      Note: The PRBs between adjacent RB sets comprise an intra-carrier guard
Y is determined by the number of RB sets contained in the BWP
The Y bits indicate a first RB set and a number of RB sets corresponding to contiguous LBT bandwidths
Note: The maximum possible value of Y is thus

$$⌈ {log}_{2} ( \frac{N ( N + 1 )}{2} ) ⌉$$

where N is the number of RB sets contained in the BWP.

Below are some of the NR Rel18 agreements on sidelink unlicensed (SL-U)

To meet OCB and PSD requirement for PSFCH transmission, at least RB-based interlace is supported at least for 15 kHz and 30 kHz SCS, FFS details.

Regarding PSFCH transmission, at least the followings alternatives can be further studied:
Alt 1: each PSFCH transmission occupies a common interlace and zero or one or more dedicated PRB(s),
Alt 2: each PSFCH transmission occupies an interlace, and may or may not further apply code domain enhancement (e.g., OCC, PRB-level cyclic shifts),
Alt 3: each PSFCH transmission occupies some dedicated PRBs and some common PRBs,
FFS details of above alternatives.

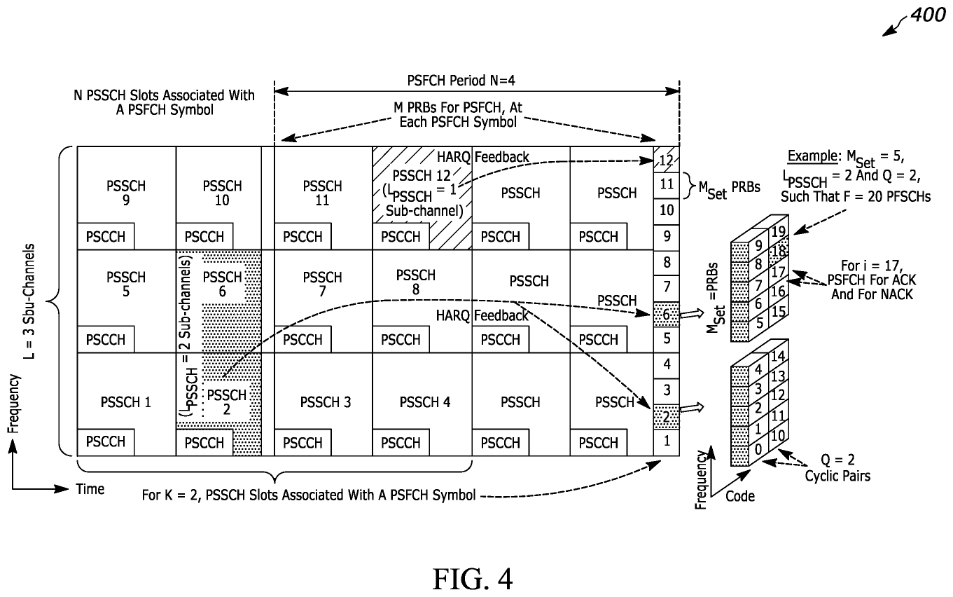

FIG. 4 illustrates a resource block mapping 400, which illustrates the physical sidelink feedback channels for hybrid automatic repeat request (HARQ) feedback associated with different transmissions.

According to a first embodiment, as we can see from the below Table 1, for 15 kHz SCS and subchannel size 12, 15 and 75 PRBs, and Table 3 for 30 kHz SCS and subchannel sizes 12, 15 and 20 PRBs, some of the PRBs belonging to a RBset not meeting the PRB requirement for a full subchannel size are named as ‘remaining PRBs’. In some cases, such as for Tables 2 and 4, where the size of the resource pool are a little more irregular, remaining PRBs may be present in most instances for the various possible subchannel sizes.

The present application discusses various embodiments associated with the handling of the remaining PRBs. However, the number of remaining PRBs can vary depending upon several factors including the size, namely number of PRBs in each subchannel, the number of PRBs in the resource pool.

Table 1, identifies for a resource pool having a 20 MHz Bandwidth with 100 PRBs at 15 KHz sub-carrier spacing, for each of a number of different subchannel sizes, a number of sub-channels and a number of remaining PRBs, if any.

| | No of sub-channels in | Remaining |
|---|---|---|
| | a resource pool with | PRBs (less |
| Subchannel | 20 MHz BW (100PRBs | than the |
| size (PRBs) | @ 15 KHz SCS) | subchannel size) |
| 10 | 10 | 0 |
| 12 | 8 | 4 |
| 15 | 6 | 10 |
| 20 | 5 | 0 |
| 25 | 4 | 0 |
| 50 | 2 | 0 |
| 75 | 1 | 25 |
| 100 | 1 | 0 |

However, in some instances a 20 MHz Bandwidth at 15 KHz sub-carrier spacing can sometimes have 106 PRBs. In such an instance, the number of subchannels and number of remaining PRBs, if any, could change, as identified below in Table 2:

| | No of sub-channels in | Remaining |
|---|---|---|
| | a resource pool with | PRBs (less |
| Subchannel | 20 MHz BW (106PRBs | than the |
| size (PRBs) | @ 15 KHz SCS) | subchannel size) |
| 10 | 10 | 6 |
| 12 | 8 | 10 |
| 15 | 7 | 1 |
| 20 | 5 | 6 |
| 25 | 4 | 6 |
| 50 | 2 | 6 |
| 75 | 1 | 31 |
| 100 | 1 | 6 |

Table 3, below, alternatively provides a number of subchannels and a number of remaining PRBs for a case including a 20 MHz Bandwidth at 30 KHz sub-carrier spacing, which assumes a resource pool having 50 PRBs.

| | | Remaining |
|---|---|---|
| | No of sub-channels in | PRBs (Resource |
| | a resource pool with | pool is not a |
| Subchannel | 20 MHz BW (50PRBs | multiple of |
| size (PRBs) | @ 15 KHz SCS) | subchannel size) |
| 10 | 5 | 0 |
| 12 | 4 | 2 |
| 15 | 3 | 5 |
| 20 | 2 | 10 |
| 25 | 2 | 0 |
| 50 | 1 | 0 |

Still further, the values change as follows, if you assume that the resource pool has 51 PRBs, as identified in table 4, below.

| | | Remaining |
|---|---|---|
| | No of sub-channels in | PRBs (Resource |
| | a resource pool with | pool is not a |
| Subchannel | 20 MHz BW (51PRBs | multiple of |
| size (PRBs) | @ 15 KHz SCS) | subchannel size) |
| 12 | 4 | 3 |
| 15 | 3 | 6 |
| 20 | 2 | 11 |
| 25 | 2 | 1 |
| 50 | 1 | 1 |

Correspondingly, depending upon the circumstances, there are many instances in which a resource block set after a set of sub-channels are defined can have a number of remaining PRBs that are not part of a defined sub-channel. For example, for a resource pool size of 100 PRBs, with a subchannel size of 12 PRBs, the number of remaining PRBs is 4.

The PSFCH RB based interlace configuration may contain L interlaces containing N PRBs in each interlace, where L and M are preconfigured in a resource pool
Option 1: L PSFCH interlaces may be equal to one PSCCH/PSSCH subchannel.
Option 2: L PSFCH interlaces may be equal to one PSCCH/PSSCH interlace.
Option 3: L PSFCH interlaces may be equal to K PSCCH/PSSCH interlaces.
Option 4: L PSFCH common interlace may be equal to one PSCCH/PSSCH subchannel and M dedicated interlace may be equal to one PSCCH/PSSCH subchannel or one interlace or K PSCCH/PSSCH interlaces.

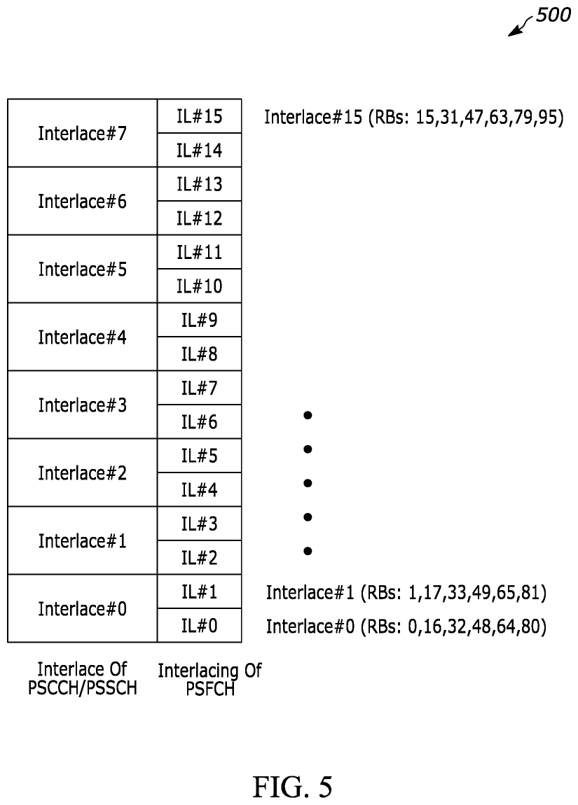

Thus, the RB based interlace configuration of PSFCH may have a different or even a greater number of interlaces from that of the RB based interlace configuration of the PSCCH/PSSCH as shown in FIG. 5. FIG. 5 illustrates an exemplary interlace mapping 500 for a 100 physical resource block set of a 20 MHz channel, which includes 8 subchannels, each having a size of 12 resource blocks for the physical sidelink control channel or the physical sidelink shared channel, as well as includes a corresponding 16 dedicated interlaces for the physical sidelink feedback channel, each having a size of 6 resource blocks. In this illustrated embodiment, 2 PSFCH interlaces are equal to one PSCCH/PSSCH subchannel, as well as one PSCCH/PSSCH interlace. In one implementation, the total number of PRBs for PSFCH may be preconfigured in a resource and the interlacing may be performed for the total number of PRBs for PSFCH.

In one implementation, the remaining PRBs may be equally spread within the RBset and RBs/interlace configuration of PSFCHs containing the remaining RBs may be configured as the common interlace.

In another implementation, the remaining PRBs may be equally spread across all RBset within a resource pool may be combined and RBs/interlace configuration of PSFCHs containing the remaining RBs may be configured as the common interlace.

In one implementation, the common interlace containing ‘O’ PRBs may be configured towards an edge of a RBset containing remaining RBs #96, #97, #98, #99 to meet the OCB requirement.

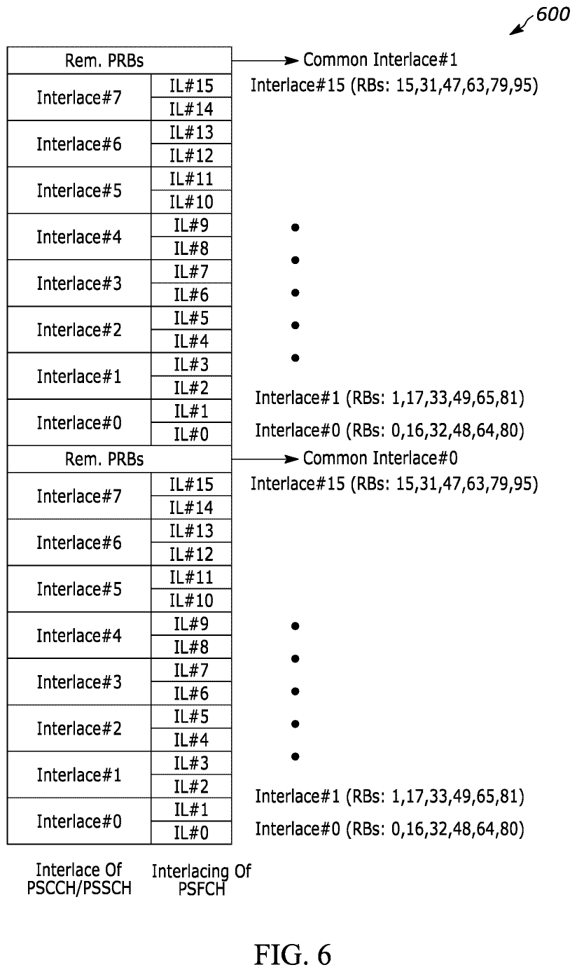

In another implementation, the common interlace may be configured in each of the RBset as shown in the FIG. 6 to meet the OCB requirement in each RBset. FIG. 6 illustrates an aggregated interlace mapping 600 for a pair of resource block sets, which highlights respective interlaces for the physical sidelink control channel or the physical sidelink shared channel, respective dedicated interlaces for the physical sidelink feedback channel, as well as respective common interlaces associated with the remaining physical resource blocks.

In another implementation, the common interlace may contain equally spaced ‘O’ remaining PRBs within a RBset to meet OCB requirements.

In another implementation, the common interlace may contain equally spaced ‘O’ remaining PRBs combined across RBset and the common interlace may be configured in each of the RBset.

In another implementation, the common interlace may contain equally spaced ‘O’ remaining PRBs combined across RBset and the common interlace may be configured in one of the RBset.

The RB size of the common interlace may be equal or smaller than the dedicated interlace and the common interlace can be constructed from the remaining PRBs of a RBset.

For content to be transmitted in the common interlace, the PSFCH transmission in the common interlace may contain PSFCH repetition or a part of the repetition from the dedicated interlace or dedicated PRBs. Further, when the common interlace is smaller relative to the dedicated interlace or dedicated PRBs, a determination as to which part of the dedicated interlace or dedicated PRBs should be used, at least one of the following criteria could be used:
Common interlace can contain part of the repetition from the dedicated interlace or dedicated PRBs starting from the content repeated from the lowest dedicated PRB or lowest dedicated interlace; or
Common interlace can contain part of the repetition from the dedicated interlace or dedicated PRBs starting from the content repeated from the lowest dedicated PRB or lowest dedicated interlace in combination with HARQ cast type such as unicast HARQ, groupcast HARQ containing dedicated ACK/NACK and then the groupcast HARQ containing common NACK.

PSFCH transmission containing dedicated ACK/NACK may be transmitted in both the dedicated and the common interlace.

However the PSFCH transmission containing common NACK should not be transmitted in the common interlace when there is no PSFCH transmission in the dedicated interlace.

In some instances, the receiver of the UE may be configured/instructed not to decode the PSFCH reception in the common interlace. Thus, the priority of PSFCH transmission in the common interlace may be preconfigured in a resource pool or in the specification or via common signaling. The priority of the PSFCH transmission in the dedicated interlace or dedicated PRBs may correspond to priority of the corresponding PSSCH for which the HARQ feedback was generated. If there are more than one common interlace, the UE transmitting PSFCH may transmit in both of the common interlaces or randomly choose one of the common interlaces for PSFCH transmission to meet the OCB requirement.

Regarding an association of PSSCH interlace and PSFCH interlace:

Within a PSFCH period, association of the PSSCH interlace and the time domain slot index of the PSSCH to the corresponding PSFCH interlace may be configured using a table or may be configurable by the network or in a resource pool. the interlacing indices, X bits where X represent number of interlaces in each RBset or across RBset within a resource pool to indicate all possible interlace combinations.

Within a PSFCH period, the association may be implicitly configured in a time first and a frequency second manner, such that the time slot #0 of PSSCH can occupy PSFCH interlace #0, and time slot #1 of PSSCH can occupy PSFCH interlace #1, and so on.

In another implementation, the PSFCH transmission within the PSFCH dedicated interlace or dedicated PRBs may further depend on the HARQ cast type such as unicast HARQ, groupcast HARQ feedback option 1 based on common NACK, and groupcast HARQ feedback option 2 based on dedicated Ack/Nack. Since only one or two RBs may be used for unicast HARQ and groupcast option 1, PSFCH carrying HARQ feedbacks for unicast HARQ and groupcast option 1 may be repeated within the dedicated interlace or dedicated PRBs to satisfy the OCB requirement. Similarly in the common interlace, PSFCH carrying HARQ feedbacks for unicast HARQ and groupcast option 1 may be repeated within the common interlace to satisfy the OCB requirement.

The PSFCH RB based interlace configuration may contain M interlaces, N PRBs in each interlace, and k PSFCH interlaces may equal to one PSCCH/PSSCH subchannel, or k PSFCH interlaces may equal to one PSCCH/PSSCH interlace. Thus, the RB based interlace configuration of PSFCH may be different from that of the RB based interlace configuration of PSCCH/PSSCH.

The common interlace containing N PRBs in each interlace may be configured towards an edge of a RBset to meet the OCB requirement.

The PSFCH transmission in the common interlace may contain PSFCH repetition from the dedicated interlace or dedicated PRBs.

A PSFCH transmission containing dedicated ACK/NACK may be transmitted in both the dedicated and the common interlace.

However the PSFCH transmission containing common NACK should not be transmitted in the common interlace where there is no PSFCH transmission in the dedicated interlace.

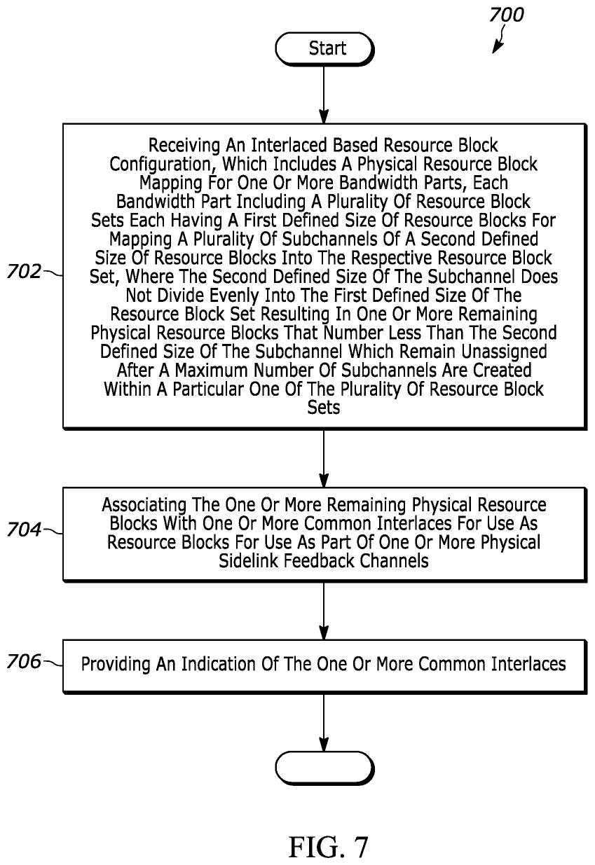

FIG. 7 illustrates a flow diagram 700 of a method in a user equipment. The method includes receiving 702 an interlaced based resource block configuration, which includes a physical resource block mapping for one or more bandwidth parts. Each bandwidth part includes a plurality of resource block sets each having a first defined size of resource blocks for mapping a plurality of subchannels of a second defined size of resource blocks into the respective resource block set, where the second defined size of the subchannel does not divide evenly into the first defined size of the resource block set. This results in one or more remaining physical resource blocks that number less than the second defined size of the subchannel which remain unassigned after a maximum number of subchannels are created within a particular one of the plurality of resource block sets. The one or more remaining physical resource blocks are associated 704 with one or more common interlaces for use as resource blocks for use as part of one or more physical sidelink feedback channels. An indication is provided 706 of the one or more common interlaces.

In some instances, the interlaced based resource configuration can be received from a network.

In some instances, the interlaced based resource configuration can be received as part of a resource pool pre-configuration for an unlicensed sidelink carrier.

In some instances, the one or more physical sidelink feedback channels can include physical resource blocks associated with the defined plurality of subchannels, which have one or more dedicated interlaces for use as part of the one or more physical sidelink feedback channels. In some of these instances, the number of physical resource blocks for use as part of the one or more physical sidelink feedback channels associated with the one or more common interlaces can be less than the number of physical resource blocks for use as part of the one or more physical sidelink feedback channels having the one or more dedicated interlaces. Further, the physical resource blocks associated with the one or more common interlaces can include physical sidelink feedback channel repetition from the physical resource blocks of the one or more physical sidelink feedback channels having the one or more dedicated interlaces.

In some instances, the remaining physical resource blocks can occupy an edge of the resource block set.

In some instances, the remaining physical resource blocks can be spread across the resource block set. In some of these instances, the remaining physical resource blocks can be spread equally across the resource block set. Further, an aggregated grouping of remaining physical resource blocks for multiple resource block sets, which are associated with one or more common interlaces for use as the resource blocks for use as part of the one or more physical sidelink feedback channels can be spread equally across the multiple resource block sets.

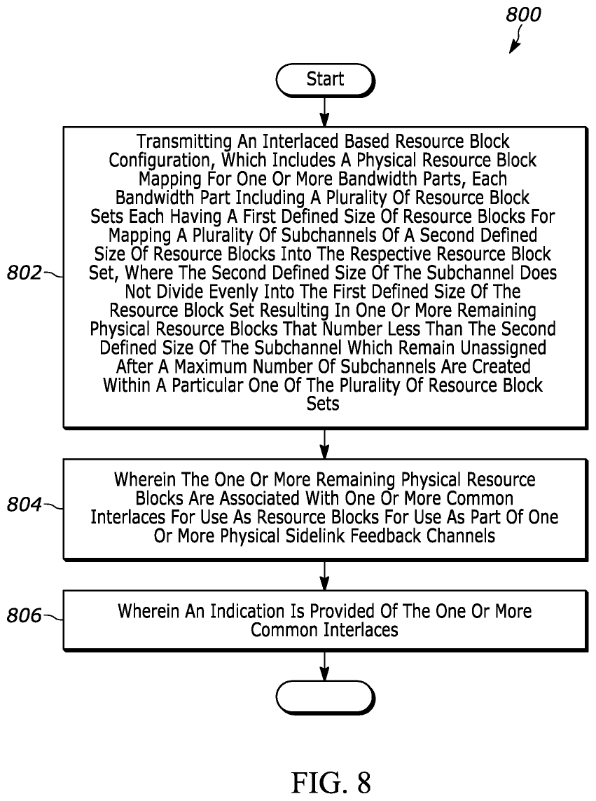

FIG. 8 illustrates a flow diagram 800 of a method in a network entity. The method includes transmitting 802 an interlaced based resource block configuration, which includes a physical resource block mapping for one or more bandwidth parts. Each bandwidth part includes a plurality of resource block sets each having a first defined size of resource blocks for mapping a plurality of subchannels of a second defined size of resource blocks into the respective resource block set, where the second defined size of the subchannel does not divide evenly into the first defined size of the resource block set. This results in one or more remaining physical resource blocks that number less than the second defined size of the subchannel which remain unassigned after a maximum number of subchannels are created within a particular one of the plurality of resource block sets. The one or more remaining physical resource blocks are associated 804 with one or more common interlaces for use as resource blocks for use as part of one or more physical sidelink feedback channels. An indication is provided 806 of the one or more common interlaces.

It should be understood that, notwithstanding the particular steps as shown in the figures, a variety of additional or different steps can be performed depending upon the embodiment, and one or more of the particular steps can be rearranged, repeated or eliminated entirely depending upon the embodiment. Also, some of the steps performed can be repeated on an ongoing or continuous basis simultaneously while other steps are performed. Furthermore, different steps can be performed by different elements or in a single element of the disclosed embodiments.

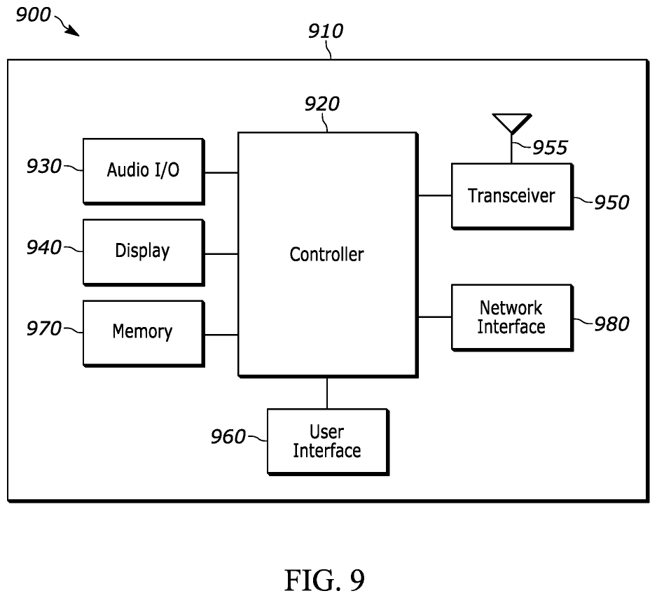

FIG. 9 is an example block diagram of an apparatus 900, such as the wireless communication device 110, according to a possible embodiment. The apparatus 900 can include a housing 910, a controller 920 within the housing 910, audio input and output circuitry 930 coupled to the controller 920, a display 940 coupled to the controller 920, a transceiver 950 coupled to the controller 920, an antenna 955 coupled to the transceiver 950, a user interface 960 coupled to the controller 920, a memory 970 coupled to the controller 920, and a network interface 980 coupled to the controller 920. The apparatus 900 can perform the methods described in all the embodiments.

The display 940 can be a viewfinder, a liquid crystal display (LCD), a light emitting diode (LED) display, a plasma display, a projection display, a touch screen, or any other device that displays information. The transceiver 950 can include a transmitter and/or a receiver. The audio input and output circuitry 930 can include a microphone, a speaker, a transducer, or any other audio input and output circuitry. The user interface 960 can include a keypad, a keyboard, buttons, a touch pad, a joystick, a touch screen display, another additional display, or any other device useful for providing an interface between a user and an electronic device. The network interface 980 can be a Universal Serial Bus (USB) port, an Ethernet port, an infrared transmitter/receiver, an IEEE 1394 port, a WLAN transceiver, or any other interface that can connect an apparatus to a network, device, or computer and that can transmit and receive data communication signals. The memory 970 can include a random access memory, a read only memory, an optical memory, a solid state memory, a flash memory, a removable memory, a hard drive, a cache, or any other memory that can be coupled to an apparatus.

The apparatus 900 or the controller 920 may implement any operating system, such as Microsoft Windows®, UNIX®, or LINUX®, Android™, or any other operating system. Apparatus operation software may be written in any programming language, such as C, C++, Java or Visual Basic, for example. Apparatus software may also run on an application framework, such as, for example, a Java® framework, a NET® framework, or any other application framework. The software and/or the operating system may be stored in the memory 970 or elsewhere on the apparatus 900. The apparatus 900 or the controller 920 may also use hardware to implement disclosed operations. For example, the controller 920 may be any programmable processor. Disclosed embodiments may also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, the controller 920 may be any controller or processor device or devices capable of operating an apparatus and implementing the disclosed embodiments. Some or all of the additional elements of the apparatus 900 can also perform some or all of the operations of the disclosed embodiments.

The method of this disclosure can be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. The phrase “at least one of,” “at least one selected from the group of,” or “at least one selected from” followed by a list is defined to mean one, some, or all, but not necessarily all of, the elements in the list. The terms “comprises,” “comprising,” “including,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.” Furthermore, the background section is written as the inventor's own understanding of the context of some embodiments at the time of filing and includes the inventor's own recognition of any problems with existing technologies and/or problems experienced in the inventor's own work.

1. A user equipment (UE) for wireless communication, comprising:
at least one memory; and
at least one controller coupled with the at least one memory and configured to cause the UE to:
receive an interlaced based resource block (RB) configuration, that includes a physical resource block (PRB) mapping for one or more bandwidth parts (BWPs), each BWP including a plurality of RB sets each having a first defined size of RBs for mapping a plurality of subchannels of a second defined size of RBs into a respective RB set, wherein the second defined size of a subchannel does not divide evenly into the first defined size of the RB set resulting in one or more remaining PRBs that number less than the second defined size of the subchannel and remain unassigned after a maximum number of subchannels are created within a particular one of the plurality of RB sets;
associate the one or more remaining PRBs with one or more common interlaces for use as RBs for use as part of one or more physical sidelink feedback channels PSFCHs; and
provide an indication of the one or more common interlaces.

2. The UE of claim 1, wherein the interlaced based RB configuration is received from a network.

3. The UE in of claim 1, wherein the interlaced based RB configuration is received as part of a resource pool pre-configuration for an unlicensed sidelink carrier.

4. The UE of claim 1, wherein the one or more PSFCHs include PRBs associated with the defined plurality of subchannels, have one or more dedicated interlaces for use as part of the one or more PSFCHs.

5. The UE of claim 4, wherein a number of the PRBs for use as part of the one or more PSFCHs associated with the one or more common interlaces is less than a number of the PRBs for use as part of the one or more PSFCHs having the one or more dedicated interlaces.

6. The UE of claim 4, wherein the PRBs associated with the one or more common interlaces include PSFCH repetition from the PRBs of the one or more PSFCHs having the one or more dedicated interlaces.

7. The UE of claim 1, wherein the one or more remaining PRBs occupy an edge of the RB set.

8. The UE of claim 1, wherein the one or more remaining PRBs are spread across the res-RB set.

9. The UE of claim 1, wherein the one or more remaining PRBs are spread equally across the RB set.

10. The UE of claim 1, wherein an aggregated grouping of the one or more remaining PRBs for multiple RB sets, which are associated with the one or more common interlaces for use as the RB as part of the one or more PSFCHs, are spread equally across the multiple RB sets.

11-18. (canceled)

19. A network entity for wireless communication, comprising:
at least one memory; and
at least one controller coupled with the at least one memory and configured to cause the network entity to:
transmit an interlaced based resource block (RB) configuration that includes a physical resource block (PRB) mapping for one or more bandwidth parts (BWPs), each BWP including a plurality of RB sets each having a first defined size of RBs for mapping a plurality of subchannels of a second defined size of RBs into a respective RB set, wherein the second defined size of a subchannel does not divide evenly into the first defined size of the RB set resulting in one or more remaining PRBs that number less than the second defined size of the subchannel and remain unassigned after a maximum number of subchannels are created within a particular one of the plurality of RB sets;
wherein the one or more remaining PRBs are associated with one or more common interlaces for use as RBs for use as part of one or more physical sidelink feedback channels PSFCHs; and
wherein an indication is provided of the one or more common interlaces.

20. (canceled)

21. A method performed by a network entity, the method comprising:
transmitting an interlaced based resource block (RB) configuration that includes a physical resource block (PRB) mapping for one or more bandwidth parts (BWPs), each BWP including a plurality of RB sets each having a first defined size of RBs for mapping a plurality of subchannels of a second defined size of RBs into a respective RB set, wherein the second defined size of a subchannel does not divide evenly into the first defined size of the RB set resulting in one or more remaining PRBs that number less than the second defined size of the subchannel and remain unassigned after a maximum number of subchannels are created within a particular one of the plurality of RB sets;
wherein the one or more remaining PRBs are associated with one or more common interlaces for use as RBs for use as part of one or more physical sidelink feedback channels (PSFCHs); and
wherein an indication is provided of the one or more common interlaces.

22. A method performed by a user equipment (UE), the method comprising:
receiving an interlaced based resource block (RB) configuration that includes a physical resource block (PRB) mapping for one or more bandwidth parts (BWPs), each BWP including a plurality of RB sets each having a first defined size of RBs for mapping a plurality of subchannels of a second defined size of RBs into a respective RB set, wherein a second defined size of a subchannel does not divide evenly into the first defined size of the RB set resulting in one or more remaining PRBs that number less than the second defined size of the subchannel and remain unassigned after a maximum number of subchannels are created within a particular one of the plurality of RB sets;
associating the one or more remaining PRBs with one or more common interlaces for use as RBs for use as part of one or more physical sidelink feedback channels (PSFCHs); and
providing an indication of the one or more common interlaces.

23. The method of claim 22, wherein the interlaced based RB configuration is received from a network.

24. The method of claim 22, wherein the interlaced based RB configuration is received as part of a resource pool pre-configuration for an unlicensed sidelink carrier.

25. The method of claim 22, wherein the one or more PSFCHs include PRBs associated with the plurality of subchannels have one or more dedicated interlaces for use as part of the one or more PSFCHs.

26. The method of claim 25, wherein a number of the PRBs for use as part of the one or more PSFCHs associated with the one or more common interlaces is less than a number of the PRBs for use as part of the one or more PSFCHs having the one or more dedicated interlaces.

27. The method of claim 25, wherein the PRBs associated with the one or more common interlaces include PSFCH repetition from the PRBs of the one or more PSFCHs having the one or more dedicated interlaces.

28. The method of claim 22, wherein the one or more remaining PRBs at least one of occupy an edge of the RB set, are spread across the RB set, or are spread equally across the RB set.

29. The method of claim 22, wherein an aggregated grouping of the one or more remaining PRBs for multiple RB sets, which are associated with the one or more common interlaces for use as the RB as part of the one or more PSFCHs, are spread equally across the multiple RB sets.
